(19) United States
(12) Patent Application Publication
(10) Pub. No.: US 2018/0138703 A1
(43) Pub. Date: May 17, 2018

(54) POWER DISTRIBUTION UNIT CAPABLE OF AUTOMATICALLY SWITCHING POWER SOURCE

(71) Applicant: Delta Electronics, Inc., Taoyuan City (TW)

(72) Inventors: Chih-Chiang CHAN, Taoyuan City (TW); I-Chieh LI, Taoyuan City (TW); Wen-Hsiang LIN, Taoyuan City (TW)

(21) Appl. No.: 15/587,772

(22) Filed: May 5, 2017

(30) Foreign Application Priority Data
Nov. 15, 2016 (CN) 201611026813.3

(51) Int. Cl. H02J 3/00; H02J 13/00

(52) U.S. Cl. CPC H02J 3/00; H02J 13/001

(57) ABSTRACT

A power distribution unit is disclosed. The power distribution unit comprises a plurality of input assemblies respectively connected to a plurality of power sources for inputting power, a plurality of output assemblies for outputting processed power, a power distributing module for transmitting the power, and a power switch module. The power switch module switches to connect with one of the input assemblies to conduct the power source connected to the input assembly with the connected output assembly (s), and switches to connect with another input assembly to conduct another power source connected to the input assembly with the connected output assembly (s) when determining that a switching condition is satisfied. The present disclosed example can effectively save the space of arranging the power switcher, and enhance convenience of installation via integrating the power switch module into the power distribution unit.

### BACKGROUND OF THE INVENTION

### Field of the Invention

The technical field relates to power distribution unit, and more particularly related to power distribution unit capable of automatically switching power source.

### Description of Related Art

A power distribution unit (PDU) is a device capable of distributing the power energy of a single power source to a plurality of electronic apparatus according to a user's requirement.

Please refer to FIG. 1, which is a schematic view of arranging a power source switcher and a power distribution unit together according to the related art. In view of a requirement of switching between multiple power sources, a scheme of the related art as shown in FIG. 1 is provided. The scheme as shown in FIG. 1 switches the power source distributed to a power distribution unit 12 by a power source switcher 10.

As shown in FIG. 1, in above-mentioned scheme of the related art, one-end of a power source switcher 10 is connected to a plurality of power source 140, 142, another end of the power source switcher 10 is connected to a power distribution unit 12. The power distribution unit 12 is connected to the plurality of electronic apparatuses 160,162.

Under the general condition, an administrator can operate the power source switcher 10 to switch to the power source 140 for making the power energy S1 of the power source 140 flow to the power distribution unit 12 via the power source switcher 10 and making the power distribution unit 12 provide the received power energy S1 to the electronic apparatuses 160, 162.

When the administrator finds that the power source 140 is abnormal (such as a power failure), the administrator can manually operate the power source switcher 10 to switch to the power source 142 for making the power energy S2 of the power source 142 flow to the power distribution unit 12 and making the power distribution unit 12 provide the received power energy S2 to the electronic apparatuses 160, 162. Thus, the above-mentioned scheme enables the administrator to quickly switch the power source for reducing the time of power failure when the administrator finds that the power source 140 is abnormal.

Although there is above-mentioned advantage in the technical scheme of the related art, however, the scheme of the related art requires additional space to settle the power source switcher 10.

### SUMMARY OF THE INVENTION

The present disclosed example is directed to a power distribution unit capable of automatically switching power source which can connect a plurality of power sources simultaneously and switch between the power sources.

One of the disclosed examples, a power distribution unit capable of automatically switching power source, comprises:

a plurality of input assemblies respectively connected to a plurality of power sources for inputting power;

a plurality of output assemblies for outputting power;

a power distributing module connected to the input assemblies, the power distributing module transmitting power energy to a power switch module; and

the power switch module comprising:
a plurality of switch units, one-end of each switch unit being connected to the power distributing module for connecting to the input assemblies via the power distributing module, another end of each switch unit being respectively connected to at least one of the output assemblies, the switch units respectively switching to connect with one of the input assemblies to conduct the power source connected to the switched input assembly with the connected output assembly; and

a switch controller electrically connected to the switch units, controlling the switch units to switch to connect with another input assembly to conduct another power source connected to the switched input assembly with the connected output assembly when determining that a switching condition is satisfied.

One of the disclosed examples, a power distribution unit capable of automatically switching power source, comprises:

a plurality of input assemblies respectively connected to a plurality of power sources for inputting power;

a plurality of output assemblies for outputting power;

a power distributing module connected to the output assemblies, the power distributing module distributing power energy to the output assemblies; and

a power switch module, one-end of the power switch module being connected to the input assemblies, another end of the power switch module being connected to the power distributing module, the power switch module switching to connect with one of the input assemblies to conduct the power source connected to the switched input assembly with the power distributing module, and switching to connect with another input assembly to conduct another power source connected to the switched input assembly with the power distributing module when determining that a switching condition is satisfied.

The present disclosed example can effectively save the space of arranging the power switcher, and enhance convenience of installation via integrating the power switch module into the power distribution unit.

### BRIEF DESCRIPTION OF DRAWING

The features of the present disclosed example believed to be novel are set forth with particularity in the appended claims. The present disclosed example itself, however, may be best understood by reference to the following detailed description of the present disclosed example, which describes an exemplary embodiment of the present disclosed example, taken in conjunction with the accompanying drawings, in which:

FIG. 1 is a schematic view of arranging a power source switcher and a power distribution unit together according to the related art;

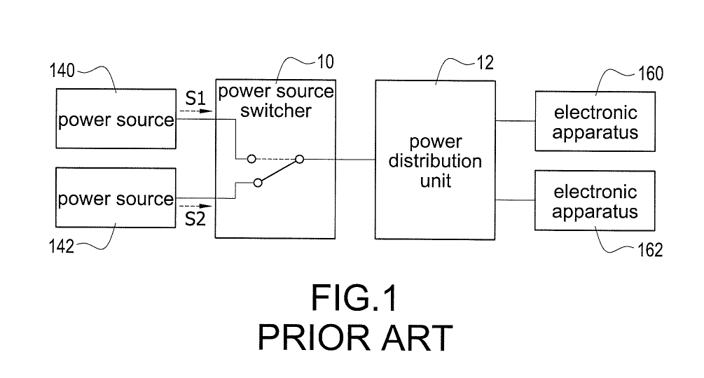

FIG. 2 is an architecture diagram of a power distribution unit according to a first embodiment of the present disclosed example;

FIG. 3 is an architecture diagram of a switch unit of the present disclosed example;

FIG. 4 is an architecture diagram of a power measuring module of the present disclosed example;

FIG. 5 is an architecture diagram of a power distribution unit according to a second embodiment of the present disclosed example; and

FIG. 6 is an architecture diagram of a power distribution unit according to a third embodiment of the present disclosed example.

### DETAILED DESCRIPTION OF THE INVENTION

In cooperation with attached drawings, the technical contents and detailed description of the present disclosed example are described thereinafter according to a preferable embodiment, being not used to limit its executing scope. Any equivalent variation and modification made according to appended claims is all covered by the claims claimed by the present disclosed example.

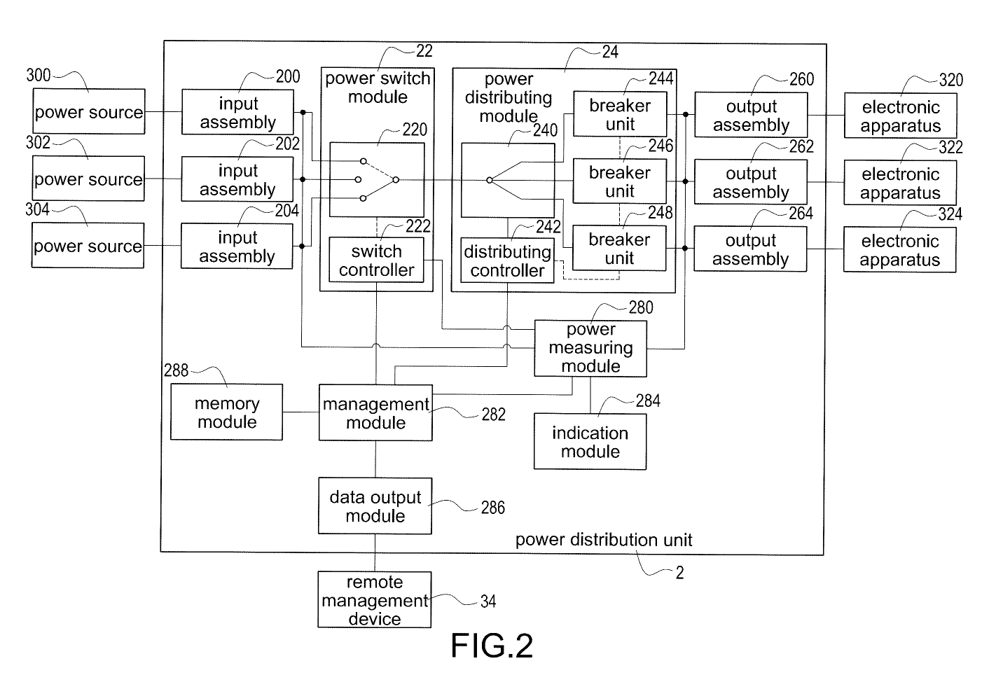

First, please refer to FIG. 2, which is an architecture diagram of a power distribution unit according to a first embodiment of the present disclosed example. In this present disclosed example, a power distribution unit (PDU) 2 is disclosed. The power distribution unit 2 can switch between a plurality of power sources, so as to provide the power energy of the different power sources to a plurality of connected electronic apparatuses.

As shown in FIG. 2, the power distribution unit 2 mainly comprises a plurality of input assemblies (the FIG. 2 takes three input assemblies 200-204 for example), a power switch module 22, a power distributing module 24 and a plurality of output assemblies (the FIG. 2 takes three output assemblies 260-264 for example).

The plurality of the input assemblies 200-204 can be any type of electronic connector, such as mains plug, USB connector and so forth. The input assemblies 200-204 are respectively used to connect to a plurality of power source 300-304 (such as mains or battery), and inputs the power energy of each connected power source 300-304.

The plurality of the output assemblies 260-264 can be any type of electronic connection port, such as mains socket, USB connection port and so forth. The output assemblies 260-264 are respectively used to connect a plurality of electronic apparatuses 320-324 (such as server), and outputs the power energy of each connected electronic apparatuses 320-324.

The power switch module 22 is settled between the input assemblies 200-204 and the power distributing module 24. More specifically, One-end of the power switch module 22 is connected to the input assemblies 200-204, another end of the power switch module 22 is connected to the power distributing module 24. The power switch module 22 can selectively switch to connect with one of the input assemblies 200-204 (take switching to the input assembly 204 for example) to conduct the power source 304 connected to the switched input assembly 204 with the power distributing module 24, so as to make the power energy of the power source 304 flow to the power distributing module 24.

In one embodiment, the power switch module 22 has an auto-switching function. More specifically, the administrator can pre-configure one or more switching condition(s), further configure the input assembly 200-204 which the power switch module 22 must switch to connect when each switching condition is satisfied, and store the configuration in the power switch module 22.

Then, after the power distributing module 2 operates (take the power switch module 22 switching to connect the input assembly 200 at the beginning for example), the power switch module 22 can constantly determine whether any switching condition is satisfied, and automatically switch to connect with the other input assembly (take switching to connect with the input assembly 204 for example) to conduct another power source 304 connected to the switched input assembly 204 with the power distributing module 24, so as to replace the power energy of the power source 300 with the power energy of the power source 304 to continually provide the power energy to the power distributing module 24.

In one embodiment, the power switch module 22 comprises a switch unit 220 and a switch controller 222 electrically connected to the switch unit 220 via a data control cable (representing in dotted line in FIG. 2). The switch unit 220 is controlled to change the connection between each input assembly 200-204 and the power distributing module 24. The switch controller 222 is used to control the switch unit 220 to change above-mentioned connection, and can determine whether any switching condition is satisfied. Furthermore, the switch controller 222 comprises memory (not shown in figure); above-mentioned switching condition is stored in the memory of the switch controller 222.

In one embodiment, above-mentioned switching condition can be a pre-default time having come, a pre-default time value having elapsed, a status of the inputted power energy or the outputted power energy being consistent with a pre-default status or any combination of above-mentioned switching conditions.

When the switching condition is the pre-default time coming or the pre-default time value elapsing, the switch controller 222 can comprises a timer (not shown in figure), and the switch controller 222 can control the switch unit 220 to switch to connect to one of the input assembly 200-204 for switching to connect to one of the power source 300-304 when the timer times that the pre-default time had come or the pre-default time value has elapsed.

For example, if the power source 300 is mains, the power source 302 is power-storing device (such as solar power-storing device), the switch unit 220 is pre-configured to switch to connect to the input assembly 200 for connect power source 300, and the switching condition is that switching to connect to the power source 302 from 1 pm to 4 pm every day. The switch controller 222 can usually switch to connect to the input assembly 200 for receiving the inputted mains, and switch to connect the input assembly 202 for retrieving the power energy from the power-storing device from 1 pm to 4 pm every day. Thus, the present disclosed example can effectively reduce the electricity consumption in the power spike period, and reduce the electricity cost.

In another example, the condition is that switching to connect to the other power source every 24 hours, the switch controller 222 can first switch to connect to the input assembly 200 for receiving the power energy of the power source 300, automatically switch to connect to the input assembly 202 for receiving the power energy of the power source 302 after the first 24 hours elapses, automatically switch to connect to the input assembly 204 for receiving the power energy of the power source 304 after the second 24 hours elapses, automatically switch to connect to the input assembly 200 for receiving the power energy of the power source 300 after the third 24 hours elapses, and so on. Thus the present disclosed example can effectively equally distribute the loading and electricity consumption of each power source 300-304, so as to extend the life of each power source apparatus.

When the switching condition is that the information of the inputted power energy or the outputted power energy is consistent with the pre-default information, the power distribution unit 2 can further comprises a power measuring module 280. The power measuring module 280 is connected to the input assembly 200-204 and the output assembly 260-264, and is electrically connected to the switch controller 222. The power measuring module 280 is used to measure the power energy received by the input assemblies 200-204 or the power energy transferred to the electronic apparatuses 320-324 via the output assemblies 260-264. Besides, the switch controller 22 can compare the information of the measured power energy measured by the power measuring module 280 with the pre-default information for determining whether the switching condition is satisfied.

In one embodiment, the power measuring module 280 measures a voltage value, a frequency value, a current value or a power factor (PF, a ratio of a real power (active power) of the power distribution unit 2 to a virtual power (reactive power) of the power distribution unit 2) of the inputted power energy or the outputted power energy. Besides, the switching condition is that the measured voltage value is greater than an voltage upper threshold (the voltage is too high), the measured voltage value is less than an voltage lower threshold (the voltage is too low), the measured frequency value is greater than a frequency upper threshold (the frequency is too high), the measured frequency value is less than a frequency lower threshold (the frequency is too low), a ratio of the measured current value to a rated current corresponding to the power source is greater than a current threshold (the current is too high) or the measured power factor is less than a power factor threshold (the power source 300-304 or the power distribution unit 2 is abnormal).

In one embodiment, the power measuring module 280 measures a number of voltage sets or a total harmonic distortion (THD) of the current conducted power source 300-304. Besides, the switching condition is that the number of voltages sets is not consistent with a pre-default number of phases (the power energy is phase-loss, for example, the three-phase AC power normally comprises three sets of voltages, if the measured number of voltages is less than 3, the inputted three-phase AC power is phase-loss) or the total harmonic distortion is greater than a harmonic distortion threshold (the power distribution unit 2 is abnormal).

The power distributing module 24 is connected to a plurality of output assemblies 260-264, and is used to distribute the power energy to each output assembly 260-264.

In one embodiment, the power distributing module 24 can first execute a process (such as phase inversion process, rectification treatment process, buck process or the other power process) to the inputted power energy, and distribute the processed to each output assembly 260-264.

In one embodiment, the power distributing module 24 comprises a power distribution unit 240 and a distributing controller 242 electrically connected to the power distribution unit 240. The power distribution unit 240 is used to distribute the power energy inputted by each input assembly 200-204 and the power switch module 22 to the output assembly 260-264. The distributing controller 242 is used to control the power distributing module 24.

In one embodiment, a memory (not shown in figure) of the power distributing controller 222 can store at least one rule(s) of process and distribution of the power energy, the rule(s) of process and distribution of the power energy records a specification of each power energy outputted to each output assembly 260-264. The power distributing module 24 executes the corresponded process to the inputted power energy according to the rule(s) of process and distribution of the power energy, and outputs the processed power energy to the corresponded output assembly 260-264.

For example, if the rule of process and distribution of the power energy is that the output assembly 260 outputs the AC power energy with 220 volts and 50 Hz, the output assembly 262 outputs the AC power energy with 110 volts and 50 Hz, and the output assembly 264 outputs the AC power energy with 100 volts and 60 Hz, the switch controller 222 can control the distributing unit 240 to transform the inputted power energy into the AC power energy with 220 volts and 50 Hz and output the transformed power energy to the assembly 260, transform the inputted power energy into the AC power energy with 110 volts and 50 Hz and output the transformed power energy to the assembly 262, and transform the inputted power energy into the AC power energy with 100 volts and 60 Hz and output the transformed power energy to the assembly 264.

In another example, if the inputted power energy is three-phase AC power energy, and the rule of process and distribution of the power energy is that the output assembly 260 outputs the three-phase AC power energy, the output assemblies 262, 264 output the single-phase AC power energy, the switch controller 222 can control the distributing unit 240 to output the three-phase AC power energy to the assembly 260, transform the inputted power energy into the single-phase AC power energy and output the transformed power energy to the assemblies 262, 264.

Via providing the power energy with different specifications simultaneously, the present disclosed example can be applied to more different types of electronic apparatus 320-324.

In another embodiment of the present disclosed example, the power distributing module 24 further comprises a plurality of breaker units 244-248, one-end of each breaker unit 244-248 is respectively electrically connected to the distributing unit 240, another end of each breaker unit 244-248 is respectively electrically connected to at least one of output assemblies 260-264 (FIG. 2 takes one breaker unit being connected to one output assembly 260-264 one-by-one for example). Besides, the breaker units 244-248 are electrically connected to the distributing controller 242 via data control cable (representing in dotted line in FIG. 2). Each breaker unit 244-248 is controlled by the distributing controller 242 to control a connection between the distributing unit 240 and the connected output assemblies 260-264 to connect or disconnect. In one embodiment, each breaker unit 244-248 is a relay or a breaker.

More specifically, each breaker unit 244-248 can disconnect a circuit of the distributing unit 240 and the connected output assembly 260-264 when the breaker unit 244-248 switches off, and make them connected when the breaker unit 244-248 switches on.

More specifically, the distributing controller 242 can control each breaker unit 244-248 to switches on or off according to the rule of process and distribution of the power energy. Thus, the present disclosed example can output or stop outputting the power energy to any output assembly 260-264 according to the rule of process and distribution of the power energy configured by the administrator.

In another embodiment of the present disclosed example, the power distribution unit 2 further comprises a data output module 286, a memory module 288 and a management module 282. The data output module 286 is used to connect a remote management device 34 for communication. The memory module 288 is used to store data. The management module 282 is electrically connected to the power measuring module 280, the data output module 286, the memory module 288, the switch controller 222 and the distributing controller 242.

In one embodiment, data output module 286 is a serial communication interface (such as Controller Area Network bus (CAN bus) interface, RS-232 interface or RS-485 interface) or an Ethernet interface. When the data output module 286 is the serial communication interface, the data output module 286 is connected to the remote management device 34 via a serial communication cable. When the data output module 286 is the Ethernet interface, the data output module 286 is connected to the remote management device 34 via local area network (LAN) or Internet.

In one embodiment, the management module 282 can receive the switching condition from the remote management device 34 and forward to the switch controller 222, or receive the rule of process and distribution of the power energy and transfer the rule of process and distribution of the power energy to the distributing controller 242. Besides, the management module 282 can collect the information of the power energy measured by the power measuring module 280 from the power measuring module 280, and transfer the information of the power energy to the remote management device 34 via the data output module 286. Thus, the administrator can operate the remote management device 34 to remotely monitor power distribution unit 2.

In one embodiment, the management module 282 can further transfer a power-switching notification to the remote management device 34 when detecting that the switch controller 222 controls the switch unit 220 to automatically switch to connect to one of input assemblies 200-204. Or, the management module 282 can also transfer a switching on/off notification to the remote management device 34 when detecting that the switch controller 222 controls any breaker unit 244-248 to switch on or off.

In another embodiment of the present disclosed example, the power distribution unit 2 further comprises indication module 284 (such as LED indicator light or buzzer), the indication module 284 is electrically connected to power measuring module 280 and used for alert. More specifically, the power measuring module 280 can alert via the indication module 284 when determining that the power energy is abnormal.

In another embodiment of the present disclosed example, the power distribution unit 2 further comprises a case (not shown in the figure), above-mentioned case completely covers the power switch module 22, the power distributing module 24, the power measuring module 280, the management module 282, the memory module 288, and covers at least one part of the input assembly 200-204, the output assembly 260-264, the indication module 284 and the data output module 286 for providing protection.

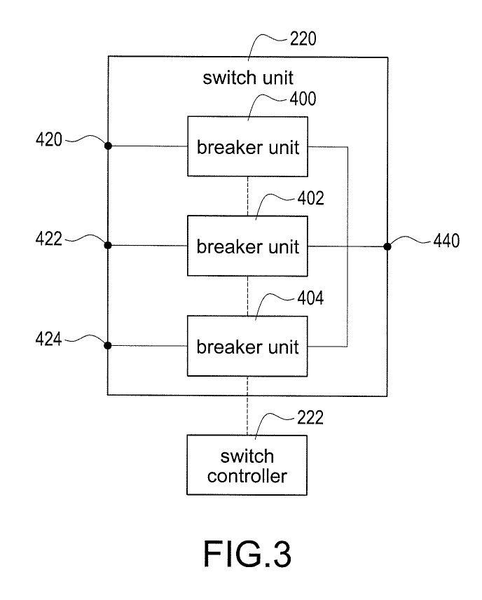

Please simultaneously refer to FIG. 3, which is an architecture diagram of a switch unit of the present disclosed example. As shown in figure, in another embodiment of the present disclosed example, the switch unit 220 of the power switch module 22 can comprise a plurality of breaker units 400-404 respectively electrically connected to the switch controller 222. The operating principle of each breaker unit 400-404 is the same or similar as above-mentioned breaker unit 244-248 of the power distributing module 24, the relevant description is omitted for brevity. In one embodiment, the breaker units 400-404 is electrically connected to the switch controller 222 via the data control cable (representing in dotted line in FIG. 3).

In this embodiment, one-end (the contacts 420-424) of each breaker units 400-404 is respectively connected to each input assembly 200-204, another end (the contact 440) of each breaker units 400-404 is connected to the distributing unit 240 of the power distributing module 24 in common. The switch controller 222 can control each breaker unit 400-404 to switch on or off via the data control cable for controlling a connection between each contact 420-424 and the contact 440 to connect or disconnect. In one embodiment, the breaker units 400-404 are a relay or a breaker.

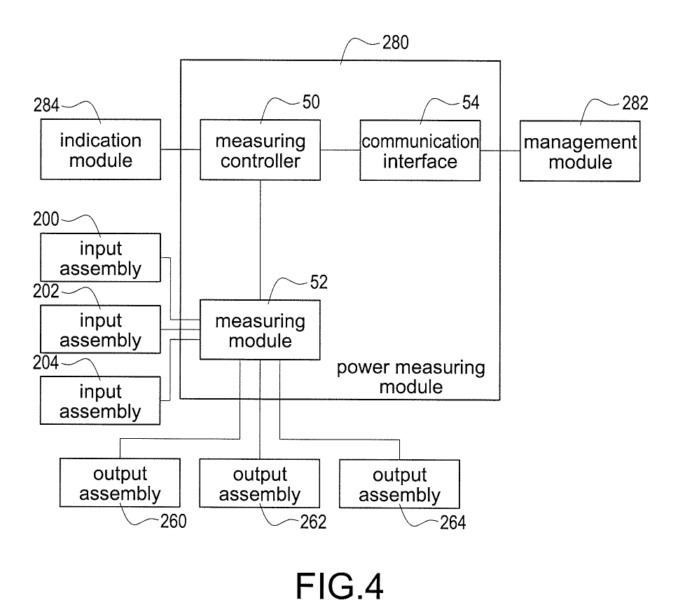

Please simultaneously refer to FIG. 4, which is an architecture diagram of a power measuring module of the present disclosed example. As shown in figure, in another embodiment of the present disclosed example, the power measuring module 280 comprises a measuring module 52, a communication interface 54 and a measuring controller electrically connected to above-mentioned elements.

The measuring module 52 is connected to the input assemblies 200-204 and the output assemblies 260-264 for respectively measuring the power energy inputted by the input assemblies 200-204 and/or the power energy outputted by the output assembly 260-264, and generates the information of the measured power energy.

The communication interface 54 is connected to the management module 282 via a transmission cable for communication. In one embodiment, the communication interface 54 is a serial communication interface (such as CAN bus interface, RS-232 interface or RS-485 interface). In one embodiment, the measuring module 52 is an Integrated Circuit chip (IC chip).

The measuring controller 50 is electrically connected to the indication module 284. The measuring controller 50 can retrieve the information of the power source from the measuring module 52, and control the indication module 284 alert when detecting that the power energy is abnormal (such as the voltage being too high or too low, the frequency being too high or too low, the current being too high, the power source 300-304 or the power distribution unit 2 is abnormal or the inputted power energy is phase-loss).

In one embodiment, measuring controller 50 is an IC chip, is connected to the indication module 284 via the pin(s) of general-purpose input/output (GPIO), and is connected to the measuring module 52 and the communication interface 54 via the pin(s) of Universal Asynchronous Receiver/Transmitter (UART).

In one embodiment, both the measuring controller 50 and the measuring module 52 comprise a clock generator, the clock generator is used to assist for controlling, timing, adjusting processing speed, data access and communication, and so on.

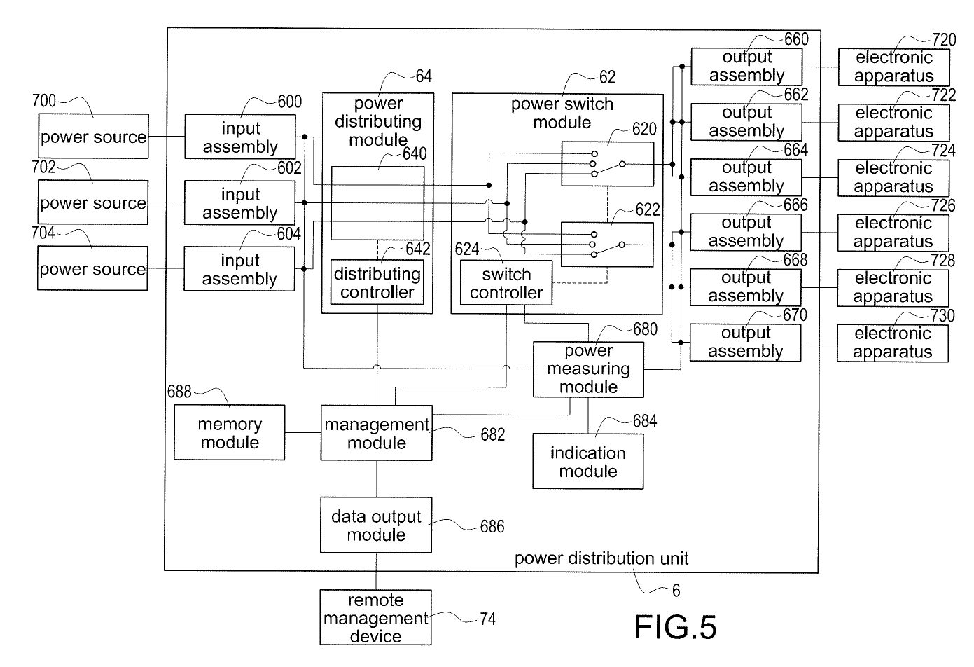

Please refer to FIG. 5, which is an architecture diagram of a power distribution unit according to a second embodiment of the present disclosed example. This embodiment discloses another power distribution unit 6, wherein the input assemblies 600-604, the power distributing module 64, the distributing unit 640, the distributing controller 642, the power switch module 62, the switch unit 620-622, the switch controller 624, the output assemblies 660-670, the power measuring module 680, the management module 682, the indication module 684, the data output module 686, the memory module 688 of the power distribution unit 6 and the power sources 700-704, the electronic apparatuses 720-730 and the remote management device 74 shown in FIG. 5 are respectively same or similar as the input assemblies 200-204, the power distributing module 24, the distributing unit 240, the distributing controller 242, the power switch module 22, the switch unit 220, the switch controller 222, the output assemblies 260-264, the power measuring module 280, the management module 282, the indication module 284, the data output module 286, the memory module 288 of the power distribution unit 2 shown in FIG. 2 and the power sources 300-304, the electronic apparatuses 320-324 and the remote management device 34 shown in FIG. 2, the relevant description is omitted for brevity. Following description will only explain the different between those two embodiments.

Compare to the first embodiment shown in FIG. 2, in this embodiment, the power switch module 62 of the power distribution unit 6 is settled between the power distributing module 64 and the output assemblies (FIG. 5 takes six output assemblies 660-670 for example). Besides, the power switch module 62 comprises a plurality of switch units (FIG. 5 takes two switch units 620-622 for example). Each switch unit 620-622 is respectively connected to at least one of the output assemblies 660-670 (FIG. 5 takes the switch unit 620 being connected to a first group consisting of the output assemblies 660-664 and the switch unit 622 being connected to a second group consisting of the output assemblies 666-670 for example). Besides, each switch unit 620-622 is electrically connected to the switch controller 624 via a data control cable (representing in dotted line in FIG. 5). The distributing unit 640 is electrically connected to the distributing controller 642 via a data control cable (representing in dotted line in FIG. 5).

Besides, each switch unit 620-622 is same or similar as the switch unit 220 shown in FIG. 3, the power measuring module 680 is same or similar as the power measuring module 280, the relevant description is omitted for brevity.

More specifically, one-end of the power distributing module 64 is connected to the input assemblies 600-604, another end of the power distributing module 64 is connected to the power switch module 62 via a plurality of cables. The power distributing module 64 receives the power energy of all the power sources 700-704 via the input assemblies 600-604, and transfers the power energy of all the power sources 700-704 to each switch unit 620-622 by different cables respectively.

One-end of each switch unit 620-622 of the power distribution unit 6 is connected to the power distributing module 64 for connecting to the input assemblies 600-604 via the power distributing module 64, another end of each switch unit 620-622 of the power distribution unit 6 is connected to the first group or the second group. The power distribution unit 6 can switch to connect one of the input assemblies 600-604 to conduct the power source 700-704 connected to the switched input assembly 600-604 with the connected first group or second group.

Please be noted that the present disclosed example can stop outputting the power energy to the connected first group or second group for power outage when all the breaker unit of any switch unit 620-622 switches off, can output the power energy to the connected first group or second group for providing power when any breaker unit of any switch unit 620-622 switches on. Thus, in this embodiment, there is not necessary to settle any breaker unit in the power distributing module 64, the power distribution unit 6 can also control to provide/stop providing power energy to the first group or second group. As a result, the present disclosed example can further reduce the volume of the power distribution unit 6, and effectively reduce the manufacturing cost.

In one embodiment, the administrator can pre-configure one or more switching condition(s) of each switch unit 620-622, and can further configure the input assembly 600-604 which the power switch unit 620-622 must switch to connect when any switching condition is satisfied, and store the configuration in a memory (not shown in figure) of the switch controller 624. Besides, the switching conditions of the switch units 620-622 can be exactly the same, parts of the same and parts of different, or completely different.

The switch controller 624 can determine whether any switching condition of each switch unit 620-622 is satisfied, and automatically control the corresponded switch unit 620-622 to switch to connect to another corresponded input assembly 600-604 when detecting that any switching condition is satisfied.

For example, if all switch units 620-622 are connected to the input assembly 600, and conduct with the power source 700, all the switching condition of the switch unit 620-622 is “phase-loss of power energy”. The switch unit 620 is configured to preferentially switch to connect to the input assembly 602; the switch unit 622 is configured to preferentially switch to connect to the input assembly 604. In this example, when determining that the received power energy is phase-loss (the switching condition is satisfied), the distributing controller 624 will control the switch unit 620 to switch to connect to the input assembly 602 and control the switch unit 622 to switch to connect to the input assembly 604.

In another example, if all the switch units 620-622 are connected to the input assembly 600, and conduct with the power source 700, the switching condition of the switch unit 620 is “phase-loss of power energy” and “voltage too low”, the switching condition of the switch unit 620 is “phase-loss of power energy” and “total harmonic distortion is greater than harmonic distortion threshold”.

In this example, when determining that the received power energy is phase-loss, the distributing controller 624 will simultaneously control the switch unit 620-622 to switch to connect to another input assembly 602-604. When determining that the voltage of the received power energy is too low, the distributing controller 624 will only control the switch unit 620 to switch to connect to another input assembly 602-604. When determining that the total harmonic distortion of the received power energy is greater than the harmonic distortion threshold, the distributing controller 624 will only control the switch unit 622 to switch to connect to another input assembly 602-604.

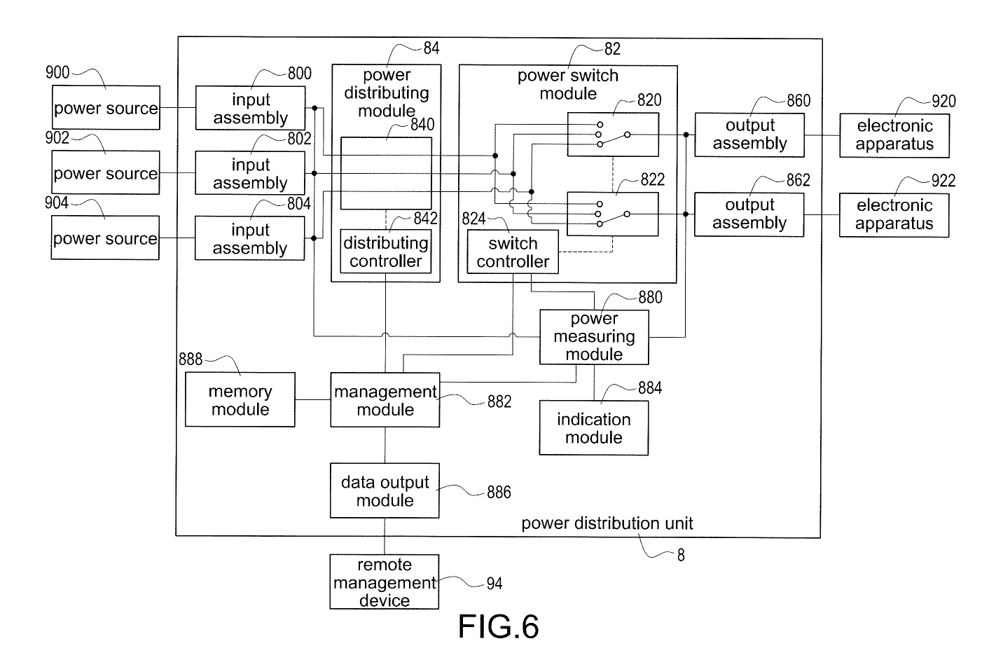

Please refer to FIG. 6, which is an architecture diagram of a power distribution unit according to a third embodiment of the present disclosed example. This embodiment discloses another power distribution unit 8, wherein the input assemblies 800-804, the power distributing module 84, the distributing unit 840, the distributing controller 842, the power switch module 82, the switch unit 820-822, the switch controller 824, the output assemblies 860-862, the power measuring module 880, the management module 882, the indication module 884, the data output module 886, the memory module 888 of the power distribution unit 8 and the power sources 900-904, the electronic apparatuses 920-922 and the remote management device 94 shown in FIG. 6 are respectively same or similar as the input assemblies 600-604, the power distributing module 64, the distributing unit 640, the distributing controller 642, the power switch module 62, the switch units 620-622, the switch controller 624, the output assemblies 660-670, the power measuring module 680, the management module 682, the indication module 684, the data output module 686, the memory module 688 of the power distribution unit 6 shown in FIG. 5 and the power sources 700-704, the electronic apparatuses 720-730 and the remote management device 74 shown in FIG. 5, the relevant description is omitted for brevity. Following description will only explain the different between those two embodiments.

Compare to the second embodiment shown in FIG. 5, in this embodiment, each switch unit 820-822 is only connected to single output assembly 860-862 (FIG. 6 takes the switch unit 820 being connected to the output assembly 860 and the switch unit 822 being connected to the output assembly 862 for example), rather than the groups shown in FIG. 5 respectively consisted of the output assemblies. Each switch unit 820-822 is same or similar as the switch unit 220 shown in FIG. 3. The power measuring module 800 is same or similar as the power measuring module 280 shown in FIG. 4, the relevant description is omitted for brevity.

When all breaker units of any switch unit 820-822 are switched off, the present disclosed example can stop outputting the power energy to the connected single output assembly 860-862 for power outage. When any breaker unit of any switch unit 820-822 is switched off, the present disclosed example can output the power energy to the connected single output assembly 860-862 for providing power. Thus, in this embodiment, there is not necessary to settle any breaker unit in the power distributing module 84, the power distribution unit 8 can also control to provide/stop providing power energy to each output assembly 860-862.

Via integrating the power switch module into the power distribution unit, the present disclosed example can effectively save the space used to settle the power source switcher, and enhance convenience of installation.

Via arranging the power switch module between the input assemblies and the power distributing module, the present disclosed example can conveniently switch the current power source used by all the output assemblies in common to another power source when the current power source is abnormal.

Via arranging the power switch module between the power distributing module and the output assemblies, the present disclosed example can respective control the power source used by each (group of) output assemblies according to the administrator's requirement, and provide better use of elasticity. When the power switch module is settled between power distributing module and the output assemblies, there is not necessary to settle any breaker unit in the power distributing module of the power distribution unit of the present disclosed example, so as to reduce the manufacturing cost.

Via arranging the power switch module between the power distributing module and the output assemblies, the present disclosed example can conveniently switch the current power source used by each (group of) output assembly to another power source according to the administrator's requirement, accurately distribute the most appropriate power source to the corresponded output assembly (namely, the present disclosed example can make each different (group of) output assembly be connected to the different power source) according to the requirement of power source required by each (group of) output assembly or the connected electronic apparatus, so as to increase the quality of the power energy provided by each (group of) output assembly.

The above mentioned are only preferred specific examples in the present disclosed example, and are not hence restrictive to the scope of claims of the present disclosed example. Therefore, those who apply equivalent changes incorporating contents from the present disclosed example are included in the scope of this application, as stated herein.

What is claimed is:

1. A power distribution unit capable of automatically switching power source, comprising:
a plurality of input assemblies respectively connected to a plurality of power sources for inputting power;
a plurality of output assemblies for outputting power;
a power distributing module connected to the input assemblies, the power distributing module transmitting power energy to a power switch module; and
the power switch module comprising:
a plurality of switch units, one-end of each switch unit being connected to the power distributing module for connecting to the input assemblies via the power distributing module, another end of each switch unit being respectively connected to at least one of the output assemblies, the switch units respectively switching to connect with one of the input assemblies to conduct the power source connected to the switched input assembly with the connected output assembly; and
a switch controller electrically connected to the switch units, controlling the switch units to switch to connect with another input assembly to conduct another power source connected to the switched input assembly with the connected output assembly when determining that a switching condition is satisfied.

2. The power distribution unit capable of automatically switching power source according to claim 1, wherein the power distribution unit capable of automatically switching power source further comprises a power measuring module connected to the input assemblies and the output assemblies for measuring the inputted power energy or the outputted power energy.

3. The power distribution unit capable of automatically switching power source according to claim 2, wherein the power measuring module measures a voltage value, a frequency value, a current value or a power factor of the inputted power energy or the outputted power energy.

4. The power distribution unit capable of automatically switching power source according to claim 2, wherein the measuring module measures a number of voltage sets or a total harmonic distortion of the conducted power source.

5. The power distribution unit capable of automatically switching power source according to claim 4, wherein the switching condition is that the number of voltage sets is not consistent with a pre-default number of phases, or the total harmonic distortion is greater than a hail ionic distortion threshold.

6. The power distribution unit capable of automatically switching power source according to claim 2, wherein the power distribution unit capable of automatically switching power source further comprises:
a data output module connected to a remote management device; and
a management module electrically connected to the power measuring module and the data output module, the management module collecting information of the inputted power energy or the outputted power energy, and transferring the collected information of the inputted power energy or the outputted power energy to the remote management device via the data output module.

7. The power distribution unit capable of automatically switching power source according to claim 6, wherein the management module is further electrically connected to the power switch module, and transfers a power-switching notification to the remote management device when detecting that the power switch module switches to connect with another one of the connected input assemblies.

8. The power distribution unit capable of automatically switching power source according to claim 6, wherein the data output module is a serial communication interface or an Ethernet interface.

9. The power distribution unit capable of automatically switching power source according to claim 1, wherein each switch unit respectively comprises a plurality of breaker units, one-end of each breaker unit is respectively connected to each input assembly via the power distributing module, another end of each breaker unit is connected to the least one of the output assemblies in common, each breaker unit respectively controls a connection between the connected output assembly and the connected input assembly to be connected or disconnected.

10. The power distribution unit capable of automatically switching power source according to claim 9, wherein the breaker unit is a breaker or a relay.

11. The power distribution unit capable of automatically switching power source according to claim 1, wherein each switch unit is respectively connected to the single output assembly.

12. The power distribution unit capable of automatically switching power source according to claim 1, wherein each switch unit is connected to the plurality of the output assemblies.

13. The power distribution unit capable of automatically switching power source according to claim 1, wherein the switching condition of one of the switch units is different from the switching condition of another switch unit.

14. A power distribution unit capable of automatically switching power source, comprising:
a plurality of input assemblies respectively connected to a plurality of power sources for inputting power;
a plurality of output assemblies for outputting power;
a power distributing module connected to the output assemblies, the power distributing module distributing power energy to the output assemblies; and
a power switch module, one-end of the power switch module being connected to the input assemblies, another end of the power switch module being connected to the power distributing module, the power switch module switching to connect with one of the input assemblies to conduct the power source connected to the switched input assembly with the power distributing module, and switching to connect with another input assembly to conduct another power source connected to the switched input assembly with the power distributing module when determining that a switching condition is satisfied.

15. The power distribution unit capable of automatically switching power source according to claim 14, wherein the power distribution unit capable of automatically switching power source further comprises a power measuring module connected to the input assemblies and the output assemblies for measuring the inputted power energy or the outputted power energy.

16. The power distribution unit capable of automatically switching power source according to claim 15, wherein the power measuring module measures a voltage value, a frequency value, a current value or a power factor of the inputted power energy or the outputted power energy.

17. The power distribution unit capable of automatically switching power source according to claim 15, wherein the measuring module measures a number of voltage sets or a total harmonic distortion of the conducted power source.

18. The power distribution unit capable of automatically switching power source according to claim 17, wherein the switching condition is that the number of voltage sets is not consistent with a pre-default number of phases, or the total harmonic distortion is greater than a harmonic distortion threshold.

19. The power distribution unit capable of automatically switching power source according to claim 15, wherein the power distribution unit capable of automatically switching power source further comprises:
a data output module connected to a remote management device; and
a management module electrically connected to the power measuring module and the data output module, the management module collecting information of the inputted power energy or the outputted power energy, and transferring the collected information of the inputted power energy or the outputted power energy to the remote management device via the data output module.

20. The power distribution unit capable of automatically switching power source according to claim 14, wherein the power switch module comprises a plurality of breaker units, one-end of each breaker unit is respectively connected to each input assembly, another end of each breaker unit is connected to the power distributing module in common, each breaker unit respectively controls a connection between the connected input assembly and the power distributing module to be connected or disconnected.
